(19) United States
(12) Patent Application Publication
(10) Pub. No.: US 2025/0322828 A1
(43) Pub. Date: Oct. 16, 2025

(54) Identifying and Mitigating Mismatched Language Signal in Multilingual Automated Speech Recognition

(71) Applicant: Google LLC, Mountain View, CA (US)

(72) Inventors: Jaeyoung Kim, Cupertino, CA (US); Kartik Audhkhasi, Mount Kisco, NY (US); Shikhar Bharadwaj, Bangalore (IN); Brian Farris, New York, NY (US); Tongzhou Chen, Sunnyvale, CA (US); Bhuvana Ramabhadran, Mt. Kisco, NY (US); Sriram Ganapathy, BanBanglore (IN)

(73) Assignee: Google LLC, Mountain View, CA (US)

(21) Appl. No.: 19/173,179

(22) Filed: Apr. 8, 2025

Related U.S. Application Data
(60) Provisional application No. 63/633,685, filed on Apr. 12, 2024.

(51) Int. Cl. G10L 15/22; G06N 3/0455; G10L 15/06; G10L 25/30

(52) U.S. Cl. CPC G10L 15/22; G06N 3/0455; G10L 15/063; G10L 25/30; G10L 2015/221

(57) ABSTRACT

A method includes receiving a sequence of acoustic frames and a language code, and generating, by a language verification model, a language verification result for a corresponding acoustic frame in the sequence of acoustic frames. For each acoustic frame having a corresponding verification result indicating that the spoken language of the corresponding acoustic frame does match the language specified by the input language code, the method includes adding, to an acoustic feature derived from the corresponding acoustic frame, a learnable embedding that maps to the input language code and generating, by an audio encoder that receives the learnable embedding added to the acoustic feature as input, a corresponding higher order feature representation. The method also includes generating, by a decoder, a probability distribution over possible speech recognition results.

### CROSS REFERENCE TO RELATED APPLICATIONS

This U.S. patent application claims priority under 35 U.S.C. § 119(e) to U.S. Provisional Application 63/633,685, filed on Apr. 12, 2024. The disclosure of this prior application is considered part of the disclosure of this application and is hereby incorporated by reference in its entirety.

### TECHNICAL FIELD

This disclosure relates to identifying and mitigating mismatched language signal in multilingual automated speech recognition.

### BACKGROUND

Automatic speech recognition (ASR), the process of taking an audio input and transcribing it into text, has greatly been an important technology that is used in mobile devices and other devices. In general, automatic speech recognition attempts to provide accurate transcriptions of what a person has said by taking an audio input (e.g., speech utterance) and transcribing the audio input into text. Modern ASR models continue to improve in both accuracy (e.g., a low word error rate (WER)) and latency (e.g., delay between the client speaking and the transcription) based on the ongoing development of deep neural networks. Despite a vast number of people being bilingual, most ASR models are only compatible with a single language. Thus, an ASR model that is compatible with several different languages while still maintaining the accuracy and latency performance metrics of modern ASR models would be desirable for the vast number of bilingual speakers.

### SUMMARY

One aspect of the disclosure provides a computer-implemented method that when executed on data processing hardware causes the data processing hardware to perform operations that include receiving, as input to a multilingual automated speech recognition (ASR) model configured to recognize speech in a plurality of different supported languages, a sequence of acoustic frames characterizing an utterance and an input language code that specifies a language of the utterance. The operations also include generating, by a language verification model, at each of a plurality of output steps, a language verification result for a corresponding acoustic frame in the sequence of acoustic frames. The language verification result indicates that a spoken language of the corresponding acoustic frame either matches or does not match the language specified by the input language code. For each acoustic frame in the sequence of acoustic frames having a corresponding verification result indicating that the spoken language of the corresponding acoustic frame does match the language specified by the input language code, the operations also include adding, to an acoustic feature derived from the corresponding acoustic frame, a learnable embedding that maps to the input language code and generating, by an audio encoder of the multilingual ASR model that receives the learnable embedding added to the acoustic feature derived from the corresponding acoustic frame as input, a corresponding higher order feature representation for the corresponding acoustic frame. For each acoustic frame in the sequence of acoustic frames having a corresponding language verification result indicating that the spoken language for the corresponding acoustic frame does not match the language specified by the input language code, the operations also include generating, by the audio encoder that receives an acoustic feature derived from the corresponding acoustic frame as input without adding the learnable embedding that maps to the input language code, a corresponding higher order feature representation for the corresponding acoustic frame. The operations also include generating, by a decoder of the multilingual ASR model, at each of the plurality of output steps, a probability distribution over possible speech recognition results, the probability distribution over possible speech recognition results based on the corresponding higher order feature representation generated by the audio encoder.

Implementations of the disclosure may include one or more of the following optional features. In some implementations, the operations further include, for each acoustic frame in the sequence of acoustic frames having a corresponding language verification result indicating that the spoken language for the corresponding acoustic frame does not match the language specified by the input language code: generating, by a language identification (LID) predictor model, a language prediction representation for the corresponding acoustic frame; and adding the language prediction representation to the acoustic feature derived from the corresponding acoustic frame, wherein generating the corresponding higher order feature representation includes generating, by the audio encoder that receives the language prediction representation added to the acoustic feature derived from the corresponding acoustic frame as input, the corresponding higher order feature representation for the corresponding acoustic frame. The LID predictor model may include: convolutional layers configured to downsample each corresponding acoustic frame to generate corresponding strided convolutions as output; a stack of multi-headed self-attention layers each having a multi-head attention mechanism, wherein a first self-attention layer in the stack of multi-headed self-attention layers is configured to receive the corresponding strided convolutions generated as output from the convolutional layers and a last self-attention layer in the stack of multi-headed self-attention layers is configured to generate a corresponding multi-head attention output for each corresponding acoustic frame; a time-pooling layer configured to time-pool the corresponding multi-head attention output; and a softmax layer configured to derive the language prediction representation for the corresponding acoustic frame from the corresponding time-pooled multi-head attention output. The stack of multi-headed self-attention layers may include a stack of conformer layers or a stack of transformer layers. Additionally or alternatively, the LID predictor model may be initially trained using a recurrent neural network-transducer (RNN-T) loss until convergence and fine-tuned using a cross-entropy loss to classify between a plurality of different languages. The multilingual ASR model may be trained jointly with the LID predictor model or trained separately from the LID predictor model.

In some examples, when generating the corresponding higher order feature representation for each corresponding acoustic frame in the sequence of acoustic frames having the corresponding language verification result indicating that the spoken language for the corresponding acoustic frame does not match the language specified by the input language code, the audio encoder is configured to receive only the acoustic frame derived from the corresponding acoustic frames as input and generate the corresponding higher order feature representation without using the input language code or any language prediction representation for the corresponding acoustic frame. In some additional implementations, the sequence of acoustic frames received as input at the multilingual ASR model characterize an utterance spoken in at least one of a plurality of different languages supported by the multilingual ASR model. In these examples, the utterance may include a code-mixed utterance including one or more words spoken in a first language and one or more other words spoken in a second language.

In some implementations, the decoder includes a prediction network and a joint network. The prediction network is configured to: receive, as input, a sequence of non-blank symbols output by a final softmax layer at each of the plurality of output steps; and generate, at each of the plurality of output steps, a dense representation. The joint network configured to: receive, as input, the dense representation generated by the prediction network at each of the plurality of output steps and the corresponding higher order feature representation generated by the audio encoder at each of the plurality of output steps; and generate, at each of the plurality of output steps, the probability distribution over possible speech recognition results.

In some examples the language verification model is configured to generate the language verification result as a binary code that includes: a first value when the language verification model determines that the spoken language of the corresponding acoustic frame matches the language specified by the input language code; or a second value when the language verification model determines that the spoken language of the corresponding acoustic frame does not match the language specified by the input language code.

The language verification model may be trained on: a plurality of positive training utterances each including audio data characterizing the utterance spoken in a respective language paired with a positive language code that specifies the same respective language of the spoken utterance; and a plurality of negative utterances each including audio data characterizing the utterance spoken in a respective language paired with a negative language code that specifies a different language than the respective language of the spoken utterance. The multilingual ASR model may be trained jointly with the language verification model or trained separately from the language verification model.

In some implementations, the input language code is derived from one of: a language setting of a computing device that captured the utterance in streaming audio, the utterance spoken by a user of the computing device; a country locale where the computing device is located; or a user-uploaded language setting when the sequence of acoustic frames characterizing the utterance are uploaded from an external source. In some additional implementations, the operations further include: generating, as output from the multilingual ASR model, a transcription of the utterance based on the probability distribution over possible speech recognition results generated by the decoder at each of the plurality of output steps; and providing the transcription for output to a downstream application, wherein the transcription includes textual words in at least one language among the plurality of different supported languages.

Another aspect of the disclosure provides a system that includes data processing hardware and memory hardware storing instructions that when executed on the data processing hardware causes the data processing hardware to perform operations that include receiving, as input to a multilingual automated speech recognition (ASR) model configured to recognize speech in a plurality of different supported languages, a sequence of acoustic frames characterizing an utterance and an input language code that specifies a language of the utterance. The operations also include generating, by a language verification model, at each of a plurality of output steps, a language verification result for a corresponding acoustic frame in the sequence of acoustic frames. The language verification result indicates that a spoken language of the corresponding acoustic frame either matches or does not match the language specified by the input language code. For each acoustic frame in the sequence of acoustic frames having a corresponding verification result indicating that the spoken language of the corresponding acoustic frame does match the language specified by the input language code, the operations also include adding, to an acoustic feature derived from the corresponding acoustic frame, a learnable embedding that maps to the input language code and generating, by an audio encoder of the multilingual ASR model that receives the learnable embedding added to the acoustic feature derived from the corresponding acoustic frame as input, a corresponding higher order feature representation for the corresponding acoustic frame. For each acoustic frame in the sequence of acoustic frames having a corresponding language verification result indicating that the spoken language for the corresponding acoustic frame does not match the language specified by the input language code, the operations also include generating, by the audio encoder that receives an acoustic feature derived from the corresponding acoustic frame as input without adding the learnable embedding that maps to the input language code, a corresponding higher order feature representation for the corresponding acoustic frame. The operations also include generating, by a decoder of the multilingual ASR model, at each of the plurality of output steps, a probability distribution over possible speech recognition results, the probability distribution over possible speech recognition results based on the corresponding higher order feature representation generated by the audio encoder.

Implementations of the disclosure may include one or more of the following optional features. In some implementations, the operations further include, for each acoustic frame in the sequence of acoustic frames having a corresponding language verification result indicating that the spoken language for the corresponding acoustic frame does not match the language specified by the input language code: generating, by a language identification (LID) predictor model, a language prediction representation for the corresponding acoustic frame; and adding the language prediction representation to the acoustic feature derived from the corresponding acoustic frame, wherein generating the corresponding higher order feature representation includes generating, by the audio encoder that receives the language prediction representation added to the acoustic feature derived from the corresponding acoustic frame as input, the corresponding higher order feature representation for the corresponding acoustic frame. The LID predictor model may include: convolutional layers configured to downsample each corresponding acoustic frame to generate corresponding strided convolutions as output; a stack of multi-headed self-attention layers each having a multi-head attention mechanism, wherein a first self-attention layer in the stack of multi-headed self-attention layers is configured to receive the corresponding strided convolutions generated as output from the convolutional layers and a last self-attention layer in the stack of multi-headed self-attention layers is configured to generate a corresponding multi-head attention output for each corresponding acoustic frame; a time-pooling layer configured to time-pool the corresponding multi-head attention output; and a softmax layer configured to derive the language prediction representation for the corresponding acoustic frame from the corresponding time-pooled multi-head attention output. The stack of multi-headed self-attention layers may include a stack of conformer layers or a stack of transformer layers. Additionally or alternatively, the LID predictor model may be initially trained using a recurrent neural network-transducer (RNN-T) loss until convergence and fine-tuned using a cross-entropy loss to classify between a plurality of different languages. The multilingual ASR model may be trained jointly with the LID predictor model or trained separately from the LID predictor model.

In some examples, when generating the corresponding higher order feature representation for each corresponding acoustic frame in the sequence of acoustic frames having the corresponding language verification result indicating that the spoken language for the corresponding acoustic frame does not match the language specified by the input language code, the audio encoder is configured to receive only the acoustic frame derived from the corresponding acoustic frames as input and generate the corresponding higher order feature representation without using the input language code or any language prediction representation for the corresponding acoustic frame. In some additional implementations, the sequence of acoustic frames received as input at the multilingual ASR model characterize an utterance spoken in at least one of a plurality of different languages supported by the multilingual ASR model. In these examples, the utterance may include a code-mixed utterance including one or more words spoken in a first language and one or more other words spoken in a second language.

In some implementations, the decoder includes a prediction network and a joint network. The prediction network is configured to: receive, as input, a sequence of non-blank symbols output by a final softmax layer at each of the plurality of output steps; and generate, at each of the plurality of output steps, a dense representation. The joint network configured to: receive, as input, the dense representation generated by the prediction network at each of the plurality of output steps and the corresponding higher order feature representation generated by the audio encoder at each of the plurality of output steps; and generate, at each of the plurality of output steps, the probability distribution over possible speech recognition results.

In some examples the language verification model is configured to generate the language verification result as a binary code that includes: a first value when the language verification model determines that the spoken language of the corresponding acoustic frame matches the language specified by the input language code; or a second value when the language verification model determines that the spoken language of the corresponding acoustic frame does not match the language specified by the input language code.

The language verification model may be trained on: a plurality of positive training utterances each including audio data characterizing the utterance spoken in a respective language paired with a positive language code that specifies the same respective language of the spoken utterance; and a plurality of negative utterances each including audio data characterizing the utterance spoken in a respective language paired with a negative language code that specifies a different language than the respective language of the spoken utterance. The multilingual ASR model may be trained jointly with the language verification model or trained separately from the language verification model.

In some implementations, the input language code is derived from one of: a language setting of a computing device that captured the utterance in streaming audio, the utterance spoken by a user of the computing device; a country locale where the computing device is located; or a user-uploaded language setting when the sequence of acoustic frames characterizing the utterance are uploaded from an external source. In some additional implementations, the operations further include: generating, as output from the multilingual ASR model, a transcription of the utterance based on the probability distribution over possible speech recognition results generated by the decoder at each of the plurality of output steps; and providing the transcription for output to a downstream application, wherein the transcription includes textual words in at least one language among the plurality of different supported languages.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system implementing a multilingual speech recognition model, a language identifier (ID) verification model, and a language ID predictor model.

FIG. 2 is a schematic view of the multilingual speech recognition model and the language ID verification model.

FIG. 3 is a schematic view of the multilingual speech recognition model and the language ID predictor model.

FIG. 4 is a flowchart of an example arrangement of operations for a method of identifying and mitigating mismatched language signal in multilingual automated speech recognition.

FIG. 5 is a schematic view of an example computing device that may be used to implement the systems and methods described herein.

Like reference symbols in the various drawings indicate like elements.

### DETAILED DESCRIPTION

End-to-end (E2E) automatic speech recognition (ASR) models are traditionally structured to operate in either a streaming mode or a non-streaming mode. Conventionally, an E2E ASR model includes an encoder and a decoder as the main components. Applications that involve end-user interaction, like voice-search or on-device dictation, may require the model to perform recognition in a streaming fashion. Here, performing recognition in a streaming fashion refers to the ASR model outputting each word of an utterance as they are spoken with as little latency as possible. Other applications, like offline video captioning, do not require the model to be streaming and can make use of future context to improve performance.

In some implementations, E2E ASR models are configured to recognize speech from multiple languages (e.g., E2E multilingual ASR models). Often, multilingual ASR models use an input language code added to the input audio data that conditions the multilingual ASR model to transcribe the input audio data into a target language indicated by the input language code. However, the spoken language of the input audio data may not always match the language specified by the input language code. This mismatch occurs often in code-switched language prevalent in multilingual societies. Unfortunately, the language mismatch can result in significant degradation in the accuracy/quality of the resulting transcription output by the multilingual ASR model. The input language code may be derived from a user defined language signal. For instance, a language setting of a computing device or a country locale of where the computing device is located that captured the input speech may indicate the target language indicated by the input language code. Similarly, the input language code may be derived from a user-uploaded language setting of a user of a computing device that captured the input speech.

Implementations herein are directed toward identifying whether or not a spoken language of input speech to be transcribed by a multilingual automated speech recognition (ASR) model matches an input language code specifying a target language and using the input language code to condition the multilingual ASR model on transcribing the input speech in the target language when the spoken language of the input speech matches the input language code. Implementations are further directed toward using a language identification (LID) predictor model to predict a language of the input speech and using the predicted language to condition the multilingual ASR model on transcribing the input speech in the predicted language when the spoken language of the input speech does not match the input language code.

Specifically, the multilingual ASR model is configured to recognize speech in a plurality of different supported language and may receive a sequence of acoustic frames characterizing an utterance and the input language code that specifies the language of the utterance. At each of a plurality of output steps, a language verification model may predict a language verification result for a corresponding acoustic frame in the sequence of acoustic frames, wherein the language verification result indicates that a spoken language of the corresponding acoustic frame ither matches or does not match the language specified by the language input code. For each acoustic frame in the sequence of acoustic frames having a corresponding verification result indicating that the spoken language of the corresponding acoustic frame does match the language specified by the input language code, implementations herein include adding a learnable embedding that maps to the input language code to an acoustic feature derived from the corresponding acoustic frame and generating, by an audio encoder of the multilingual ASR model that receives the learnable embedding added to the acoustic feature derived from the corresponding acoustic frame as input, a corresponding higher order feature representation for the corresponding acoustic frame. On the other hand, for each acoustic frame in the sequence of acoustic frames having a corresponding language verification result indicating that the spoken language for the corresponding acoustic frame does not match the language specified by the input language code, implementations instead include generating, by the audio encoder that receives an acoustic feature derived from the corresponding acoustic frame as input without adding the learnable embedding that maps to the input language code, a corresponding higher order feature representation for the corresponding acoustic frame. Finally, a decoder of the multilingual ASR model is configured to generate, at each of the plurality of output steps, a probability distribution over possible speech recognition results based on the corresponding higher order feature representation generated by the audio encoder. In some examples, for each acoustic frame in the sequence of acoustic frames having the corresponding language verification result indicating that the spoken language for the corresponding acoustic frame does not match the language specified by the input language code, the LID predictor model generates a language prediction representation for the corresponding acoustic frame and adds the language prediction representation to the acoustic feature derived from the corresponding acoustic frame. In these examples, the audio encoder receives the language prediction representation added to the acoustic feature derived from the corresponding acoustic frame as input and generates the corresponding higher order feature representation for the corresponding acoustic frame.

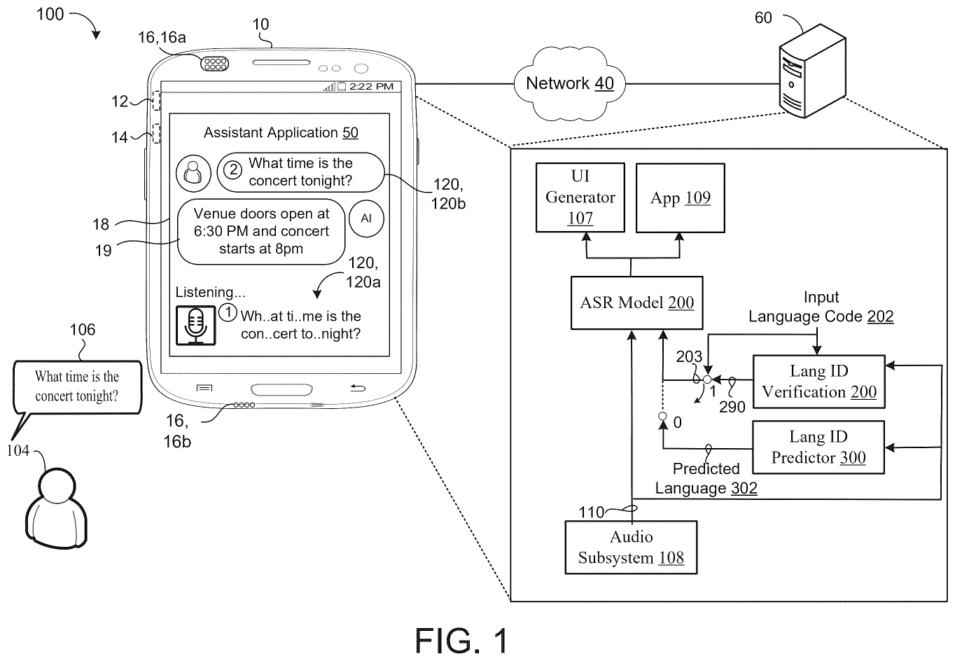

FIG. 1 is an example system 100 in a speech environment in which a user's 104 manner of interacting with a computing device, such as a user device 10, may be through voice input. The user device 10 (also referred to generally as a device 10) is configured to capture sounds (e.g., streaming audio data) from one or more users 104 within the speech environment 100. Here, the streaming audio data may refer to a spoken utterance 106 by the user 104 that functions as an audible query, a command for the user device 10, or an audible communication captured by the device 10. Speech-enabled systems of the user device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., smart phones and tablets), wearables (e.g., smart watches and headsets), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, cause the data processing hardware 12 to perform one or more operations. The user device 10 further includes an audio system 16 with an audio capture device (e.g., microphone) 16, 16a for capturing and converting spoken utterances 106 with the speech environment 100 into electrical signals and a speech output device (e.g., a speaker) 16, 16b for communicating with an audible audio signal (e.g., as output data from the user device 10). While the user device 10 may implement an array of audio capture devices 16a without departing from the scope of the present disclosure, whereby one or more capture devices 16a in the array may not physically reside on the user device 10, but be in communication with the audio system 16.

The system 100 includes a multilingual automated speech recognition (ASR) model 201 that integrates a language verification model 200 for verifying whether or not a spoken language of input speech 110 characterizing an utterance 106 matches an input language code 202 that specifies a language of the input speech 110. Optionally, the multilingual ASR model 201 may integrate a language identification (LID) predictor model 300 for generating a language prediction representation 302 for the spoken language of the input speech 110. As will become apparent, the ASR model 201 may use the input language code 202 for transcribing the input speech 110 into a script of the language specified by the input language code 202 when the language verification model 200 verifies that the spoken language of the input speech 110 matches the input language code 202. Otherwise, the ASR model 201 may not use the input language code 202 and may optionally use the language prediction representation 302 generated by the LID predictor model 300 for transcribing the input speech to a script of a language specified by the language prediction representation 302 when the language verification model 200 verifies that the spoken language of the input speech 110 does not match the input language code 202.

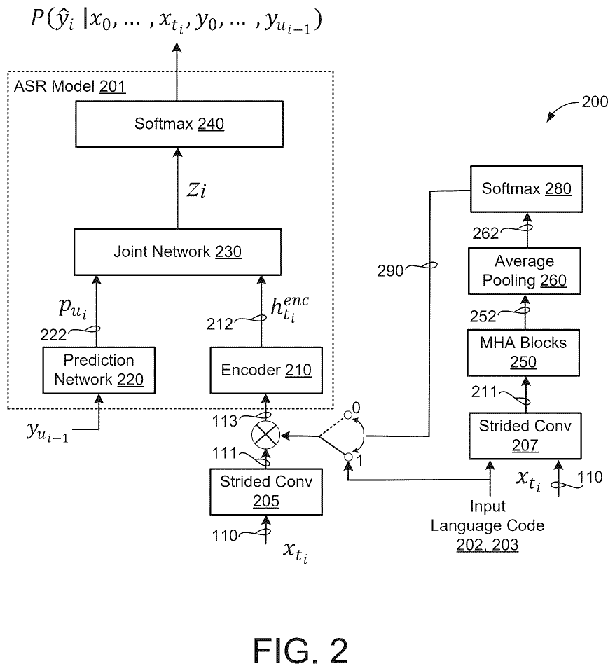

The multilingual ASR model 201, the language verification model 200, and the LID predictor model 300 may reside on the user device 10 of the user 104 and/or on a remote computing device 60 (e.g., one or more remote servers of a distributed system executing in a cloud-computing environment) in communication with the user device 10 via a network 40. In some examples, the ASR model 201 includes a recurrent neural network-transducer (RNN-T) model. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR model 201. In the example shown, the user speaks a respective utterance 106 and the audio subsystem 108 converts the utterance 106 into corresponding audio data (e.g., sequence of acoustic frames) 110 for input to the ASR model 201, the language verification model 200, and the LID predictor model 300. The language verification model 200 generates, at each output step, a language verification result 290 for a corresponding acoustic frame 110 in the sequence of acoustic frames 110. Here, the language verification result 290 indicates that a spoken language of the corresponding acoustic frame 110 either matches or does not match a language specified by an input language code that specifies a language of the utterance 106 spoken by the user 104. In some examples, the language verification result 290 generated at each output step includes a binary code that includes a first value (e.g., “1”) when the language verification model 200 determines that the spoken language of the corresponding acoustic frame 110 matches the language specified by the input language code 202 or a second value (e.g., “0”) when the language verification model 200 determines that the spoken language of the corresponding acoustic frame 110 does not match the language specified by the input language code 202. As described in greater detail below with reference to FIG. 2, for each acoustic frame 110 in the sequence of acoustic frames 110 having a corresponding verification result 290 indicating that the spoken language of the corresponding acoustic frame 110 does match the language specified by the input language code 202, the ASR model 201 may receive a learnable embedding 203 added to an acoustic feature 111 (FIG. 2) derived from the corresponding acoustic frame 110 as input. Otherwise, for those acoustic frames having corresponding verification results 290 indicating that the spoken language does not match the language specified by the input language code 202, the ASR model 201 may receive the acoustic features 111 derived from those acoustic frames as input without adding the learnable embedding 203 that pas to the input language code. Here, for each acoustic frame 110 having the corresponding language verification result 290 indicating that the spoken language for the corresponding acoustic frame 110 does not match the language specified by the input language code 202, the LID predictor model 300 may generate a language prediction representation 302 for the corresponding acoustic frame and the ASR model 201 may receive the language prediction representation 402 added to the acoustic feature 111 derived from the corresponding acoustic frame 110 as input.

In the example shown, the ASR model 201 may perform streaming speech recognition to produce an initial speech recognition result 120, 120b and generate a final speech recognition result 120, 120a by improving the initial speech recognition result 120b. The speech recognition results 120 may either correspond to a partial speech recognition result or an entire speech recognition result. Stated differently, the speech recognition result 120 may either correspond to a portion of an utterance 106 or an entire utterance 106. For example, the partial speech recognition result may correspond to a portion of a spoken utterance or even a portion of a spoken term. However, as will become apparent, the ASR model 201 performs additional processing on the final speech recognition result 120a whereby the final speech recognition result 120a may be delayed from the initial speech recognition result 120b.

The user device 10 and/or the remote computing device 60 also executes a user interface generator 107 configured to present a representation of the transcription 120 of the utterance 106 to the user 104 of the user device 10. The user interface generator 107 may display the initial speech recognition results 120b in a streaming fashion during time 1 and subsequently display the final speech recognition results 120a in a streaming fashion during time 2. Notably, the ASR model 200 outputs the final speech recognition results 120a in a streaming fashion even though the final speech recognition results 120a improve upon the initial speech recognition result 120b. In some configurations, the transcription 120 output from the ASR model 201 is processed, e.g., by a downstream application 109 executing on the user device 10 or the remote computing device 60, to execute a user command/query specified by the utterance 106. For instance, the application 109 may include a large language model (LLM) or natural language understanding (NLU) module. For instance, the utterance 106 may correspond to an input prompt directed toward a LLM-based conversational assistant application 50 and the LLM-based conversational assistant 50 is prompted using the transcription 120 to cause the LLM-based conversational assistant application 50 to generate a corresponding response 19 to the prompt. Additionally or alternatively, a text-to-speech system (not shown) (e.g., executing on any combination of the user device 10 or the remote computing device 60) may convert the transcription 120 into synthesized speech for audible output by the user device 10 and/or another device.

In the example shown, the user 104 interacts with a program or application 50 (e.g., the digital assistant application 50) of the user device 10 that uses the multilingual ASR model 201. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio systems 16 of the user device 10. In this example, the audio system 16 receives the spoken utterance 106 and converts it into a sequence of acoustic frames 110 for input to the ASR model 201, the language verification model 200, and the LID predictor model 300.

The language verification model 200 also receives the input language code 202 specifying the language of the utterance 106. The input language code 202 may be derived from a language setting of the user device 10 that captured the utterance 106 in the streaming audio. The input language code 202 may be derived from a country locale where the user device 10 is located. The input language code 202 may be derived from a user-uploaded language setting when the sequence of acoustic frames 110 characterizing the utterance 106 are uploaded from an external source.

In the example shown in FIG. 1, the digital assistant application 50 may respond to the question/prompt posed by the user 104 using natural language processing. Natural language processing generally refers to a process of interpreting written language (e.g., the initial speech recognition result 120b and/or the final speech recognition result 120a) and determining whether the written language prompts any action. In this example, the digital assistant application 50 uses an LLM or other natural language processing techniques to recognize that the question from the user 104 regards the user's schedule and more particularly a concert on the user's schedule. By recognizing these details with natural language processing, the automated assistant returns a response 19 to the user's query where the response 19 states, “Venue doors open at 6:30 PM and concert starts at 8 pm.” In some configurations, natural language processing occurs on a remote server 60 in communication with the data processing hardware 12 of the user device 10.

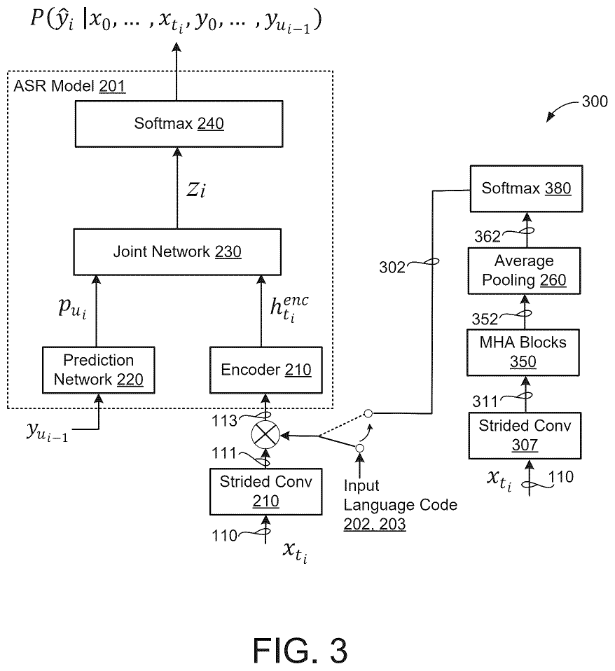

Referring to FIGS. 2 and 3, the ASR model 201 may include a Recurrent Neural Network-Transducer (RNN-T) model architecture which adheres to latency constrains associated with interactive applications. The use of the RNN-T model architecture is exemplary, and the ASR model 200 may include other architectures such as transformer-transducer and conformer-transducer model architectures among others. The RNN-T model provides a small computational footprint and utilizes less memory requirements than conventional ASR architectures, making the RNN-T model architecture suitable for performing speech recognition entirely on the user device 10 (e.g., no communication with a remote server is required). The RNN-T model architecture of the ASR model 201 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. The acoustic frames 110 may include 128-dimensional log-mel features computed over 32 millisecond (ms) frames with 10 ms frame rate and a strided convolution 205 may project the acoustic frames into 1024 dimensional audio features 111. The encoder 210 reads a sequence of d-dimensional feature vectors 113 each derived from a corresponding one of the sequence of acoustic frames 110 (e.g., x=(x₁, x₂, . . . , x_{T}), where xₜ∈ [symbol] , and produces at each output step a higher-order feature representation 212. This higher-order feature representation is denoted as

$${h}_{1}^{enc} , … , {h}_{T}^{enc} .$$

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation 222 pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(y_i┤|x_(t_i), y_0, . . . , y_(u_(i−1))), which is a distribution over the next output symbol. Stated differently, the joint network 230 generates, at each output step (e.g., time step), a probability distribution over possible speech recognition hypotheses. As used herein, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the ASR model 201 at the corresponding output step. In this manner, the ASR model 201 does not make a conditional independence assumption, rather the prediction of each symbol is conditioned not only on the acoustics but also on the sequence of labels output so far. The ASR model 201 does assume an output symbol is independent of future acoustic frames 110, which allows the ASR model 201 to be employed in a streaming fashion, a non-streaming fashion, or some combination thereof.

In some examples, the encoder network (i.e., audio encoder) 210 of the RNN-T model 201 includes a stack of self-attention layers/blocks, such as conformer blocks, each including a multi-headed self-attention mechanism. Here, each conformer block includes a series of multi-headed self attention, depth wise convolution and feed-forward layers. In some examples, the audio encoder 210 includes 24 multi-head attention layers (e.g., Conformer layers). The prediction network 220 may have one 768-dimensional LSTM layer and the joint network 230 may project the higher-order feature representations 212 output by the audio encoder 210 and the dense representations 222 output by the prediction network 220 into 640 hidden units to produce posteriors over 4,096 word pieces. The Softmax layer 240 may be composed of a unified word piece or grapheme set that is generated using all unique word pieces or graphemes in a plurality of training data sets.

FIG. 2 shows the language verification model 200 generating the corresponding language verification result 290 for a corresponding acoustic frame 110 at each of the plurality of output steps. When the verification result 290 indicates that the spoken language of the corresponding acoustic frame matches the language specified by the input language code 202 (e.g., language verification result is equal to “1”), the ASR model 201 receives the learnable embedding 203 that maps to the input language code 202 such that the learnable embedding 203 is added to the acoustic feature 111 derived from the corresponding acoustic frame and the audio encoder 210 generates the corresponding higher order feature representation 212 for the corresponding acoustic frame based on the learnable embedding 203 added to the acoustic feature 211 derived from the corresponding acoustic frame. When the verification result 290 indicates that the spoken language of the corresponding acoustic frame does not match the language specified by the input language code 202 (e.g., language verification result is equal to “0”), the ASR model 201 may receive only the acoustic feature 111 derived from the corresponding acoustic frame without adding the learnable embedding 203 such that the encoder 210 generates the corresponding higher order feature representation 212 for the corresponding acoustic frame 110 based on only the acoustic feature 111 derived from the corresponding acoustic frame. Optionally, a language prediction representation 302 generated by the LID predictor model 300 for the corresponding acoustic frame 110 may be added to the acoustic feature 111 derived from the corresponding acoustic frame such that the encoder 210 generates the corresponding higher order feature representation based on the language prediction representation 302 added to the acoustic feature 111.

The acoustic frames 110 may include 128-dimensional log-mel features computed over 32 millisecond (ms) frames with 10 ms frame rate and a strided convolution 207 may project the acoustic frames into 1024 dimensional audio features to match the dimension of the audio features 111 input to the ASR model 201. The strided convolution 207 also projects the learnable embedding 203 that maps to the input language code 202 into the same dimension and adds the learnable embedding 203 thereto to provide corresponding audio features 211 having the same dimension of the audio features 111 input to the ASR model 201. The language verification model 200 includes may include 18 million parameters and include a stack of multi-head attention blocks 250. The multi-head attention blocks 250 may include conformer blocks or transformer blocks. In some examples, the stack of multi-head attention blocks 250 includes a stack of 12 conformer blocks. The stack of multi-head attention blocks 250 processes the corresponding audio features 211 to generate an attention output 252 at each of the plurality of output steps followed by an average pooling layer 260 performing average pooling on the attention output 252 to provide an average pooled result 262 as input to a final softmax layer 280 configured to provide the language verification result.

The language verification model 200 may be trained to generate the language verification result 290 as a binary output (e.g., “1” or “0”) using labeled training utterances that each include audio data characterizing the utterance and a corresponding language label that serves as a ground-truth input language code for the utterance. The language verification model 200 may be trained on both positive and negative training utterances. Here, the negative training utterances may be generated by flipping the ground-truth input language codes to a randomly-selected incorrect input language code for a fixed percentage of the labeled training utterances. The language verification model 200 and the ASR model 201 may be trained jointly or separately. The language verification model 200 and the LID predictor model 300 may be trained jointly or separately.

FIG. 3 shows the LID predictor model 300 generating the corresponding language prediction representation 302 for a corresponding acoustic frame 110 at each of the plurality of output steps. When the language verification result 290 determined by the language verification model 200 of FIG. 2 for the corresponding acoustic frame 110 indicates that the spoken language of the corresponding acoustic frame 110 does not match the language specified by the input language code 202 (e.g., language verification result is equal to “0”), the LID predictor model 300 may activate a switch connection to provide the corresponding predicted language representation 302 as input to the ASR model 200 to be added to the acoustic feature 111 derived from the corresponding acoustic frame to provide the corresponding d-dimensional feature 113 as input to the encoder 210. Otherwise, the switch connection instead provides the learnable embedding 203 that maps to the input language code as input to the ASR model 200 to be added to the acoustic feature 111.

The acoustic frames 110 may include 128-dimensional log-mel features computed over 32 millisecond (ms) frames with 10 ms frame rate and a strided convolution 307 may project the acoustic frames into 1024 dimensional audio features to match the dimension of the audio features 311 input to the ASR model 201. The LID predictor model 300 includes may include 120 million parameters and include a stack of multi-head attention blocks 350. The multi-head attention blocks 350 may include conformer blocks or transformer blocks. In some examples, the stack of multi-head attention blocks 350 includes a stack of 5 conformer blocks. The stack of multi-head attention blocks 350 processes the corresponding audio features 311 to generate an attention output 352 at each of the plurality of output steps followed by an average pooling layer 360 that time-pools the attention output 252 to provide a pooled result 362 as input to a final softmax layer 380 configured to provide the language prediction representation 302. In some implementations, the language prediction representation 302 generated by the LID predictor model 300 is always used by the ASR model 201 in place of the input language code 202 or in scenarios when no input language code 202 is available for the incoming utterance 106 to be transcribed.

Notably, the LID predictor model 300 can be biased by non-linguistic factors like channel characteristics, background noise, and speaker traits. In some examples, the LID predictor model 300 is jointly trained with the ASR model 201 to learn phonetic representation to encourage the LID predictor model 300 to prioritize fundamental language structures when predicting language representations from speech. The LID predictor model 300 may be initially trained with an RNN_T loss until convergence, followed by fine-tuning with cross-entropy loss to classify between a predetermined number of languages. In some examples, the predetermined number of languages includes 10 different Indian languages. For instance, the 10 different Indian languages may include Hindi, Indian English, Gujarati, Tamil, Marathi, Telugu, Urdu, Kannada, Bengali, and Malayalam. The training utterances may be segmented with a maximum length equal to 30-seconds. In other examples, the LID predictor model 300 is trained separately from the ASR model 201.

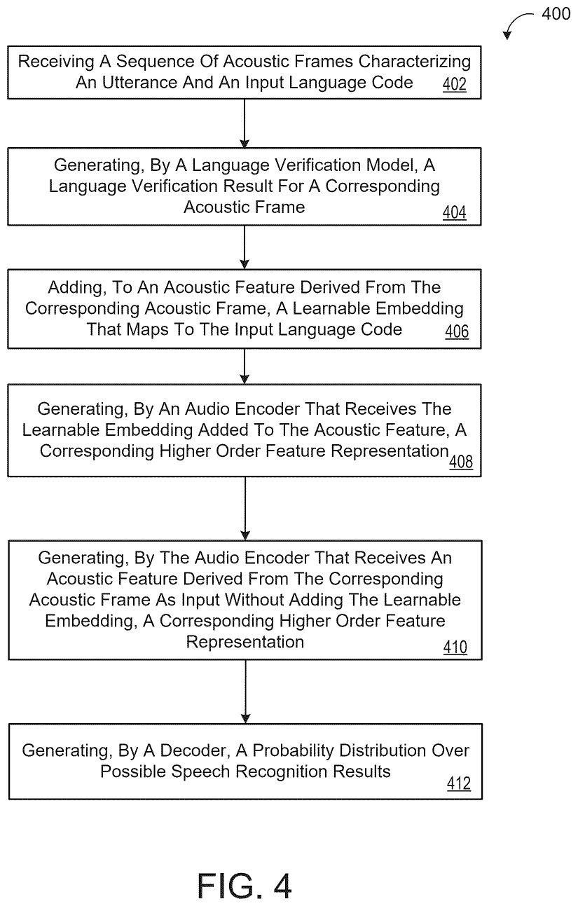

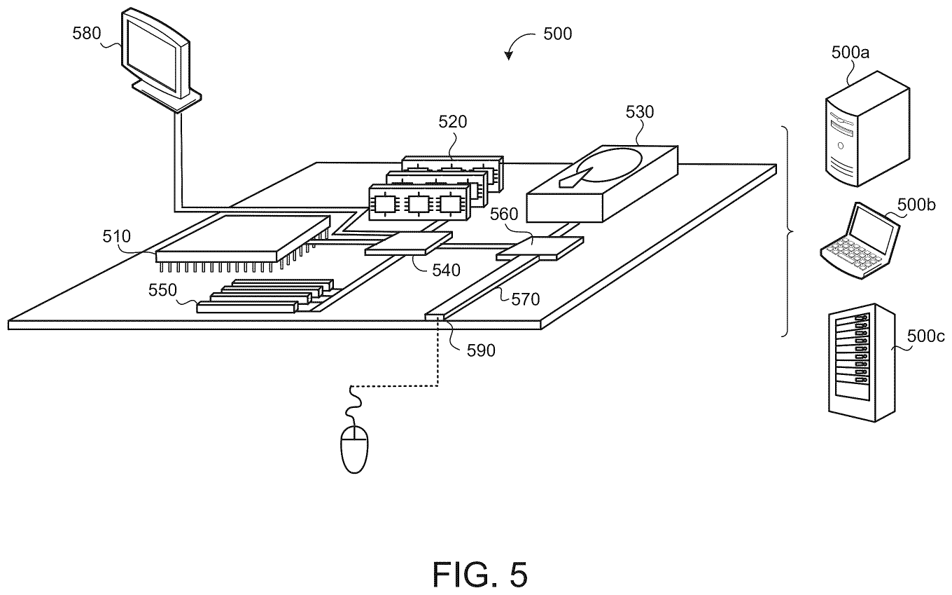

FIG. 4 is a flowchart of an example arrangement of operations for a method 400 of identifying and mitigating mismatched language signal in multilingual automated speech recognition. The method 400 may execute on data processing hardware 510 (FIG. 5) based on instructions stored on memory hardware 520 (FIG. 5) in communication with the data processing hardware 510. The data processing hardware 510 may include the data processing hardware 12 of the user device 10 or the data processing hardware 510 may reside on the remote system 60. The memory hardware 520 may include the memory hardware 14 of the user device 10 or the memory hardware 520 may reside on the remote system 60. At operation 402, the method 400 includes receiving, as input to a multilingual automated speech recognition (ASR) model 201 configured to recognize speech in a plurality of different supported languages, a sequence of acoustic frames 110 characterizing an utterance 106 and an input language code 202 that specifies a language of the utterance 106. At operation 404, the method 400 includes generating, by a language verification model 200, at each of a plurality of output steps, a language verification result 290 for a corresponding acoustic frame 110 in the sequence of acoustic frames 110. Here, the language verification result 290 indicates that a spoken language of the corresponding acoustic frame 110 either matches or does not match the language specified by the input language code 202.

For each acoustic frame 110 in the sequence of acoustic frames 110 having a corresponding verification result 290 indicating that the spoken language of the corresponding acoustic frame 110 does match the language specified by the input language code 202, the method 400 performs operations 406 and 408. At operation 406, the method 400 includes adding, to an acoustic feature 111 derived from the corresponding acoustic frame 110, a learnable embedding 203 that maps to the input language code 202. At operation 408, the method 400 includes generating, by an audio encoder 210 of the multilingual ASR model 201 that receives the learnable embedding added 203 to the acoustic feature 111 derived from the corresponding acoustic frame 110 as input, a corresponding higher order feature representation 212 for the corresponding acoustic frame 110. In some examples, the audio encoder 210 includes a causal encoder followed by a non-causal encoder.

At operation 410, for each acoustic frame 110 in the sequence of acoustic frames 110 having a corresponding language verification result 290 indicating that the spoken language for the corresponding acoustic frame does not match the language specified by the input language code 202, the method 400 includes generating, by the audio encoder 210 that receives an acoustic feature 111 derived from the corresponding acoustic frame 110 as input without adding the learnable embedding 203 that maps to the input language code 202, a corresponding higher order feature representation 210 for the corresponding acoustic frame 110. At operation 412, the method 400 includes generating, by a decoder 220, 230 of the multilingual ASR model 201, at each of the plurality of output steps, a probability distribution over possible speech recognition results. Here, the probability distribution over possible speech recognition results is based on the corresponding higher order feature representation 212 generated by the audio encoder 210 at the corresponding output step.

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high-speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving, as input to a multilingual automated speech recognition (ASR) model configured to recognize speech in a plurality of different supported languages, a sequence of acoustic frames characterizing an utterance and an input language code that specifies a language of the utterance;
generating, by a language verification model, at each of a plurality of output steps, a language verification result for a corresponding acoustic frame in the sequence of acoustic frames, the language verification result indicating that a spoken language of the corresponding acoustic frame either matches or does not match the language specified by the input language code;
for each acoustic frame in the sequence of acoustic frames having a corresponding verification result indicating that the spoken language of the corresponding acoustic frame does match the language specified by the input language code:
adding, to an acoustic feature derived from the corresponding acoustic frame, a learnable embedding that maps to the input language code; and
generating, by an audio encoder of the multilingual ASR model that receives the learnable embedding added to the acoustic feature derived from the corresponding acoustic frame as input, a corresponding higher order feature representation for the corresponding acoustic frame;
for each acoustic frame in the sequence of acoustic frames having a corresponding language verification result indicating that the spoken language for the corresponding acoustic frame does not match the language specified by the input language code, generating, by the audio encoder that receives an acoustic feature derived from the corresponding acoustic frame as input without adding the learnable embedding that maps to the input language code, a corresponding higher order feature representation for the corresponding acoustic frame; and
generating, by a decoder of the multilingual ASR model, at each of the plurality of output steps, a probability distribution over possible speech recognition results, the probability distribution over possible speech recognition results based on the corresponding higher order feature representation generated by the audio encoder.

2. The method of claim 1, wherein the operations further comprise, for each acoustic frame in the sequence of acoustic frames having a corresponding language verification result indicating that the spoken language for the corresponding acoustic frame does not match the language specified by the input language code:
generating, by a language identification (LID) predictor model, a language prediction representation for the corresponding acoustic frame; and
adding the language prediction representation to the acoustic feature derived from the corresponding acoustic frame,
wherein generating the corresponding higher order feature representation comprises generating, by the audio encoder that receives the language prediction representation added to the acoustic feature derived from the corresponding acoustic frame as input, the corresponding higher order feature representation for the corresponding acoustic frame.

3. The method of claim 2, wherein the LID predictor model comprises:
convolutional layers configured to downsample each corresponding acoustic frame to generate corresponding strided convolutions as output;
a stack of multi-headed self-attention layers each having a multi-head attention mechanism, wherein a first self-attention layer in the stack of multi-headed self-attention layers is configured to receive the corresponding strided convolutions generated as output from the convolutional layers and a last self-attention layer in the stack of multi-headed self-attention layers is configured to generate a corresponding multi-head attention output for each corresponding acoustic frame;
a time-pooling layer configured to time-pool the corresponding multi-head attention output; and
a softmax layer configured to derive the language prediction representation for the corresponding acoustic frame from the corresponding time-pooled multi-head attention output.

4. The method of claim 3, wherein the stack of multi-headed self-attention layers comprises a stack of conformer layers or a stack of transformer layers.

5. The method of claim 2, wherein the LID predictor model is initially trained using a recurrent neural network-transducer (RNN-T) loss until convergence and fine-tuned using a cross-entropy loss to classify between a plurality of different languages.

6. The method of claim 2, wherein the multilingual ASR model is one of:
trained jointly with the LID predictor model; or
trained separately from the LID predictor model.

7. The method of claim 1, wherein, when generating the corresponding higher order feature representation for each corresponding acoustic frame in the sequence of acoustic frames having the corresponding language verification result indicating that the spoken language for the corresponding acoustic frame does not match the language specified by the input language code, the audio encoder is configured to receive only the acoustic frame derived from the corresponding acoustic frames as input and generate the corresponding higher order feature representation without using the input language code or any language prediction representation for the corresponding acoustic frame.

8. The method of claim 1, wherein the sequence of acoustic frames received as input at the multilingual ASR model characterize an utterance spoken in at least one of a plurality of different languages supported by the multilingual ASR model.

9. The method of claim 8, wherein the utterance comprises a code-mixed utterance comprising one or more words spoken in a first language and one or more other words spoken in a second language.

10. The method of claim 1, wherein the decoder comprises:
a prediction network configured to:
receive, as input, a sequence of non-blank symbols output by a final softmax layer at each of the plurality of output steps; and
generate, at each of the plurality of output steps, a dense representation; and
a joint network configured to:
receive, as input, the dense representation generated by the prediction network at each of the plurality of output steps and the corresponding higher order feature representation generated by the audio encoder at each of the plurality of output steps; and
generate, at each of the plurality of output steps, the probability distribution over possible speech recognition results.

11. The method of claim 1, wherein the language verification model is configured to generate the language verification result as a binary code comprising:
a first value when the language verification model determines that the spoken language of the corresponding acoustic frame matches the language specified by the input language code; or
a second value when the language verification model determines that the spoken language of the corresponding acoustic frame does not match the language specified by the input language code.

12. The method of claim 1, wherein the language verification model is trained on:
a plurality of positive training utterances each comprising audio data characterizing the utterance spoken in a respective language paired with a positive language code that specifies the same respective language of the spoken utterance; and
a plurality of negative utterances each comprising audio data characterizing the utterance spoken in a respective language paired with a negative language code that specifies a different language than the respective language of the spoken utterance.

13. The method of claim 1, wherein the multilingual ASR model is one of:
trained jointly with the language verification model; or
trained separately from the language verification model.

14. The method of claim 1, wherein the input language code is derived from one of:
a language setting of a computing device that captured the utterance in streaming audio, the utterance spoken by a user of the computing device;
a country locale where the computing device is located; or
a user-uploaded language setting when the sequence of acoustic frames characterizing the utterance are uploaded from an external source.

15. The method of claim 1, wherein the operations further comprise:
generating, as output from the multilingual ASR model, a transcription of the utterance based on the probability distribution over possible speech recognition results generated by the decoder at each of the plurality of output steps; and
providing the transcription for output to a downstream application,
wherein the transcription comprises textual words in at least one language among the plurality of different supported languages.

16. A system comprising:
data processing hardware; and
memory hardware in communication with the data processing hardware and storing instructions that when executed on the data processing hardware causes the data processing hardware to perform operations comprising:
receiving, as input to a multilingual automated speech recognition (ASR) model configured to recognize speech in a plurality of different supported languages, a sequence of acoustic frames characterizing an utterance and an input language code that specifies a language of the utterance;
generating, by a language verification model, at each of a plurality of output steps, a language verification result for a corresponding acoustic frame in the sequence of acoustic frames, the language verification result indicating that a spoken language of the corresponding acoustic frame either matches or does not match the language specified by the input language code;
for each acoustic frame in the sequence of acoustic frames having a corresponding verification result indicating that the spoken language of the corresponding acoustic frame does match the language specified by the input language code:
adding, to an acoustic feature derived from the corresponding acoustic frame, a learnable embedding that maps to the input language code; and
generating, by an audio encoder of the multilingual ASR model that receives the learnable embedding added to the acoustic feature derived from the corresponding acoustic frame as input, a corresponding higher order feature representation for the corresponding acoustic frame:
for each acoustic frame in the sequence of acoustic frames having a corresponding language verification result indicating that the spoken language for the corresponding acoustic frame does not match the language specified by the input language code, generating, by the audio encoder that receives an acoustic feature derived from the corresponding acoustic frame as input without adding the learnable embedding that maps to the input language code, a corresponding higher order feature representation for the corresponding acoustic frame; and
generating, by a decoder of the multilingual ASR model, at each of the plurality of output steps, a probability distribution over possible speech recognition results, the probability distribution over possible speech recognition results based on the corresponding higher order feature representation generated by the audio encoder.

17. The system of claim 16, wherein the operations further comprise, for each acoustic frame in the sequence of acoustic frames having a corresponding language verification result indicating that the spoken language for the corresponding acoustic frame does not match the language specified by the input language code:
generating, by a language identification (LID) predictor model, a language prediction representation for the corresponding acoustic frame; and
adding the language prediction representation to the acoustic feature derived from the corresponding acoustic frame,
wherein generating the corresponding higher order feature representation comprises generating, by the audio encoder that receives the language prediction representation added to the acoustic feature derived from the corresponding acoustic frame as input, the corresponding higher order feature representation for the corresponding acoustic frame.

18. The system of claim 17, wherein the LID predictor model comprises:
convolutional layers configured to downsample each corresponding acoustic frame to generate corresponding strided convolutions as output;
a stack of multi-headed self-attention layers each having a multi-head attention mechanism, wherein a first self-attention layer in the stack of multi-headed self-attention layers is configured to receive the corresponding strided convolutions generated as output from the convolutional layers and a last self-attention layer in the stack of multi-headed self-attention layers is configured to generate a corresponding multi-head attention output for each corresponding acoustic frame;
a time-pooling layer configured to time-pool the corresponding multi-head attention output; and
a softmax layer configured to derive the language prediction representation for the corresponding acoustic frame from the corresponding time-pooled multi-head attention output.

19. The system of claim 18, wherein the stack of multi-headed self-attention layers comprises a stack of conformer layers or a stack of transformer layers.

20. The system of claim 17, wherein the LID predictor model is initially trained using a recurrent neural network-transducer (RNN-T) loss until convergence and fine-tuned using a cross-entropy loss to classify between a plurality of different languages.

21. The system of claim 17, wherein the multilingual ASR model is one of:
trained jointly with the LID predictor model; or
trained separately from the LID predictor model.

22. The system of claim 16, wherein, when generating the corresponding higher order feature representation for each corresponding acoustic frame in the sequence of acoustic frames having the corresponding language verification result indicating that the spoken language for the corresponding acoustic frame does not match the language specified by the input language code, the audio encoder is configured to receive only the acoustic frame derived from the corresponding acoustic frames as input and generate the corresponding higher order feature representation without using the input language code or any language prediction representation for the corresponding acoustic frame.

23. The system of claim 16, wherein the sequence of acoustic frames received as input at the multilingual ASR model characterize an utterance spoken in at least one of a plurality of different languages supported by the multilingual ASR model.

24. The system of claim 23, wherein the utterance comprises a code-mixed utterance comprising one or more words spoken in a first language and one or more other words spoken in a second language.

25. The system of claim 16, wherein the decoder comprises:
a prediction network configured to:
receive, as input, a sequence of non-blank symbols output by a final softmax layer at each of the plurality of output steps; and
generate, at each of the plurality of output steps, a dense representation; and
a joint network configured to:
receive, as input, the dense representation generated by the prediction network at each of the plurality of output steps and the corresponding higher order feature representation generated by the audio encoder at each of the plurality of output steps; and
generate, at each of the plurality of output steps, the probability distribution over possible speech recognition results.

26. The system of claim 16, wherein the language verification model is configured to generate the language verification result as a binary code comprising:
a first value when the language verification model determines that the spoken language of the corresponding acoustic frame matches the language specified by the input language code; or
a second value when the language verification model determines that the spoken language of the corresponding acoustic frame does not match the language specified by the input language code.

27. The system of claim 16, wherein the language verification model is trained on:
a plurality of positive training utterances each comprising audio data characterizing the utterance spoken in a respective language paired with a positive language code that specifies the same respective language of the spoken utterance; and
a plurality of negative utterances each comprising audio data characterizing the utterance spoken in a respective language paired with a negative language code that specifies a different language than the respective language of the spoken utterance.

28. The system of claim 16, wherein the multilingual ASR model is one of:
trained jointly with the language verification model; or
trained separately from the language verification model.

29. The system of claim 16, wherein the input language code is derived from one of:
a language setting of a computing device that captured the utterance in streaming audio, the utterance spoken by a user of the computing device;
a country locale where the computing device is located; or
a user-uploaded language setting when the sequence of acoustic frames characterizing the utterance are uploaded from an external source.

30. The system of claim 16, wherein the operations further comprise:
generating, as output from the multilingual ASR model, a transcription of the utterance based on the probability distribution over possible speech recognition results generated by the decoder at each of the plurality of output steps; and
providing the transcription for output to a downstream application,
wherein the transcription comprises textual words in at least one language among the plurality of different supported languages.
